(19) United States
(12) Patent Application Publication
(10) Pub. No.: US 2006/0073273 A1
(43) Pub. Date: Apr. 6, 2006

(54) Method for manufacturing optical elements

(75) Inventor: Iwao Yokoyama, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJINON SANO CORPORATION, Sano-shi (JP)

(21) Appl. No.: 11/231,994

(22) Filed: Sep. 22, 2005

(30) Foreign Application Priority Data
Oct. 4, 2004 (JP) 2004-291469

(51) Int. Cl. B05D 5/06

(52) U.S. Cl. 427/162

(57) ABSTRACT

For manufacturing an optical element having a plural number of different optical multi-layer coatings deposited on a surface of a substrate plate, a peeling metal film is deposited on a large substrative base material which is divided into a plural number of subsections, a pattern of an optical multi-layer coating is transferred to each one of the subsections of the substrative base material by the use of a mask member, followed by etching of the peeling metal film, deposition of optical multi-layer coatings on the substrative base material, and removal of the peeling metal film. The substrative base material is processed through a similar deposition stage repeatedly until a required number of optical multi-layer coatings are deposited in each subsection. In a final stage, the substrative base material is cut to separate the individual subsections which will make the units of optical elements of ultimate products. A mask member to be used in an initial deposition stage is provided with an alignment pattern in two subsections to deposit alignment marks of optical multi-layer coatings at two corresponding positions on the substrative base material. On the other hand, a mask member to be used in a succeeding deposition stage is provided with light transmitting portions thereby to see-through the alignment marks of optical multi-layer coatings which were deposited in the initial deposition stage.

### BACKGROUND OF THE INVENTION

1. Field of the Art

This invention relates to a method for manufacturing optical elements with a plural number of optical coatings of different optical characteristics deposited on a substrate plate.

2. Background of the Art

For CDs (Compact Discs) and DVDs (Digital Versatile Discs) which are recently coming into wide use, there have been developed and put in use disk drives which employ one and same optical pickup for the purpose of reducing the number of necessary parts and for the sake of compactness in construction. More specifically, the optical pickup uses a laser beam of 780 nm in wavelength for a CD in combination with an objective lens with a numerical aperture of approximately 0.4 to converge the laser beam toward a disc having a 1.2 mm thick substrate plate, while using a laser beam of 650 nm in wavelength for a DVD in combination with an objective lens with a numerical aperture of approximately 0.6 to converge the laser beam toward a disc having a 0.6 mm thick substrate plate. In the case of a single optical pickup, a numerical aperture limitation filter with a wavelength selecting function is applied.

The numerical aperture limitation filter has a circular optical coating, with optical characteristics of transmitting CD and DVD laser beams, deposited on a center portion of a glass or crystal substrate of a predetermined shape. Deposited around the central optical coating is another optical coating which transmits a DVD laser beam alone and does not transmit a CD laser beam. Either one of these optical coatings has a wavelength selecting function, while the other one of the optical coating has a function of adjusting the phase of incident light.

Disclosed in Japanese Laid-Open Patent Application H11-328715 is a method for manufacturing a wave selecting filter of the sort as mentioned above. According to this method, firstly a filter film is deposited on the outer side of a circular region by etching a metal film using a photoresist pattern as a mask member, and then a metal film is deposited on the entire region including the filter film, followed by etching of the metal film using another photoresist pattern as a mask member and deposition of a phase adjusting film within the circular region.

The numerical aperture limiting filter (wave selecting filter) disclosed in the above-mentioned Japanese Laid-Open Patent Application H11-328715 is constituted by two different films (a filter film and a phase adjusting film). Boundaries of these films need to be located in extremely strictly controlled positions. In order to transmit a laser beam only through the phase adjusting film, the cross section of the laser beam should precisely coincide with the phase adjusting film region. If there is a large positional error therebetween, it would give rise to a problem of overlapping or a problem of a gap space opened in a film pattern, which has adverse effects on optical characteristics of the filter.

### SUMMARY OF THE INVENTION

With the foregoing situations in view, it is an object of the present invention to provide a method for manufacturing high precision optical elements having a plural number of different optical coatings deposited on a substrate plate in such a way as to guarantee accuracy in optical characteristics of the respective optical coatings.

According to the present invention, in order to achieve the above-stated objective, there is provided a method for manufacturing an optical element having a plural number of different optical multi-layer coatings deposited on a surface of a rectangular substrate plate through a plural number of deposition stages each comprising the steps of depositing a peeling metal film on a surface of a substrative base material, dividing the substrative base material into a plural number of rectangular subsections, transferring a pattern to each subsection by the use of a mask member, etching the peeling metal film, depositing an optical multi-layer coating on each one of the subsections, and stripping off the peeling metal film, and finally cutting the substrative base material to separate the subsections from each other;

characterized in that said method comprises the steps of:

using in an initial deposition stage a mask member being provided with an alignment patter in two subsections in addition to patterns of an optical multi-layer coating to be transferred to other subsections, for depositing an alignment mark of an optical multi-layer coating at two position on the substrative base material; and

using in a succeeding deposition stage another mask member being provided with a light transmitting portion at positions corresponding to the alignment marks of optical multi-layer coatings, and being aligned relative to the substrative base material by recognizing through the light transmitting portion the alignment marks covered under a peeling metal film.

The above and other objects, features and advantages of the present invention will become apparent from the following particular description of the invention, taken in conjunction with the accompanying drawings which show by way of example preferred embodiments of the invention. Needless to say, the present invention should not be construed as being limited to particular forms shown in the drawings.

### BRIEF DESCRIPTION OF THE DRAWINGS

In the accompanying drawings:

FIG. 1 is a plan view of an optical element;

FIG. 2 shows a number of optical characteristic diagrams of optical coatings;

FIG. 3 is a flow chart of a process for manufacturing the optical element;

FIG. 4 is a plan view of a substrative base material;

FIG. 5 is an illustration explanatory of a method for transferring a pattern of circular optical multi-layer coatings onto the substrative base material by the use of a first mask member;

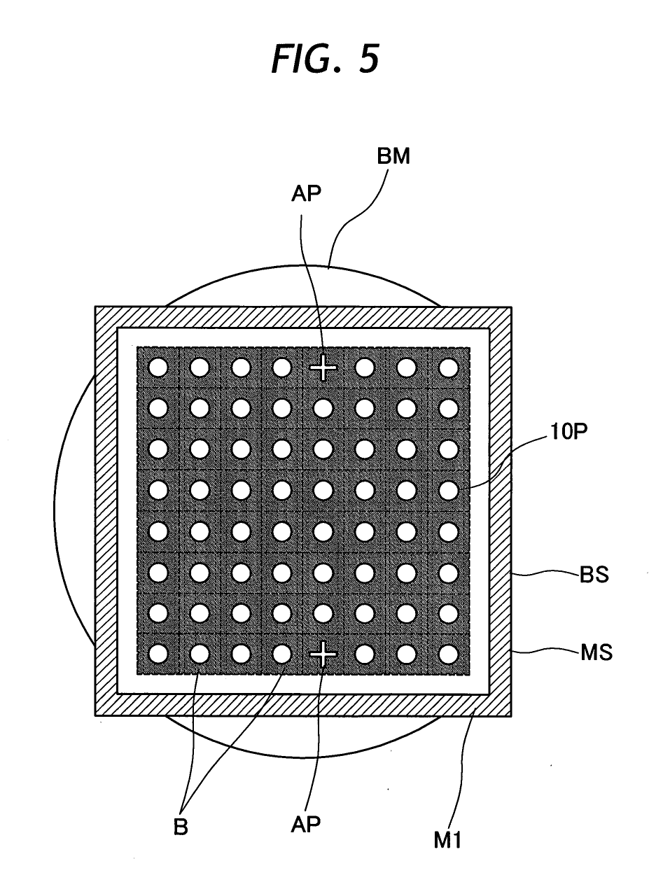

FIG. 6 is a plan view of the substrative base material on which the circular optical multi-layer coatings are deposited along with alignment marks in the form of optical multi-layer coatings;

FIG. 7 is an illustration explanatory of a method for transferring patterns of ring-shape optical multi-layer coatings onto the substrative base material by the use of a second mask member;

FIG. 8 is an illustration explanatory of an alignment mark optical multi-layer coating and a mark recognition pattern which are brought into alignment with each other;

FIG. 9 is a sectional view of one subsection of the substrative base material having a peeling metal film deposited on an alignment mark;

FIG. 10 is a plan view of a substrative base material with circular optical multi-layer coatings, ring-shaped optical multi-layer coatings and alignment mark optical multi-layer coatings deposited thereon;

FIG. 11 is an illustration explanatory of a method for transferring a pattern of peripheral optical multi-layer coating onto the substrative base material by the use of a third mask member;

FIG. 12 is a plan view of a substrative base material with circular optical multi-layer coatings, ring-shape optical multi-layer coatings and alignment mark optical multi-layer coatings deposited thereon;

FIG. 13 is a plan view of a substrative base material in another embodiment, in the process of transferring patterns of circular optical multi-layer coatings onto the substrative base material by the use of a fourth mask member;

FIG. 14 is a plan view of a substrative base material in the another embodiment, in the process of transferring patterns of ring-shape optical multi-layer coatings onto the substrative base material by the use of a fifth mask member;

FIG. 15 is a plan view of a substrative base material in the another embodiment, in the process of transferring a pattern of a peripheral optical multi-layer coating onto the substrative base material by the use of a sixth mask member;

FIG. 16 is a plan view of a substrative base material in the another embodiment, with circular optical multi-layer coatings, ring-shape optical multi-layer coatings and alignment mark optical multi-layer coatings deposited thereon;

FIG. 17 is a plan view of a substrative base material in another embodiment, with circular optical multi-layer coatings, ring-shape optical multi-layer coatings, a peripheral optical multi-layer coating and alignment mark optical multi-layer coatings deposited thereon;

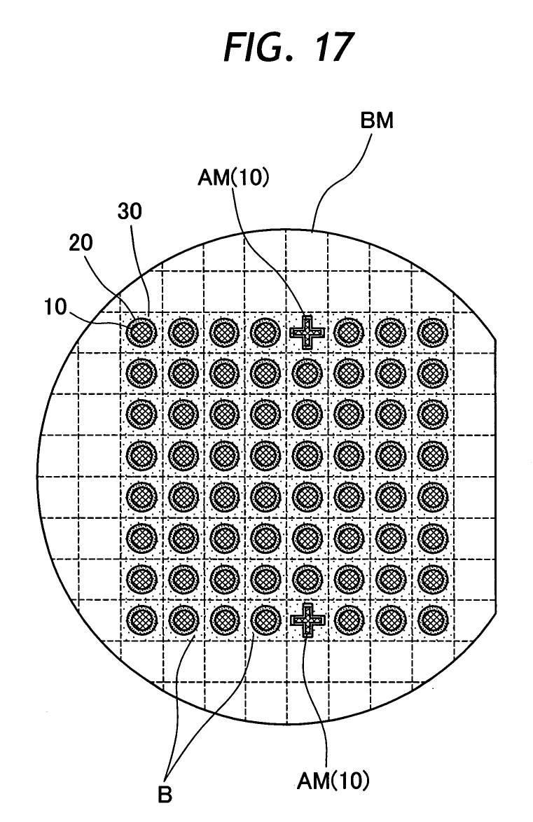

FIG. 18 is a plan view of an optical element with two ring-shape optical multi-layer coatings; and

FIG. 19 shows diagrams of wave characteristics of the respective optical coatings on the optical element with two ring-shape optical multi-layer coatings.

### BEST MODE FOR CARRYING OUT THE INVENTION

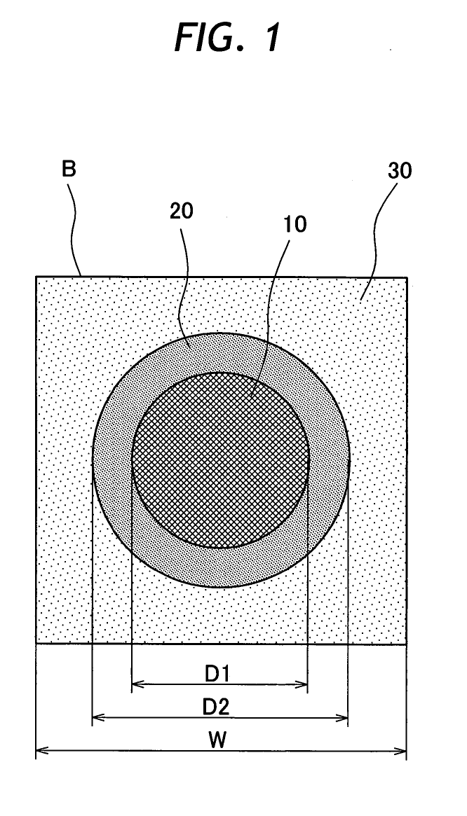

Now, the present invention is described more particularly by way of its preferred embodiments. Shown in FIG. 1 is an example of optical elements which are obtained as ultimate products. The optical element has a circular optical multi-layer coating 10 deposited on a center region of a square substrate plate B, along with a ring-shape optical multi-layer coating 20 which is deposited around the circular optical multi-layer coating 10 in concentrically circumscribing relation with the latter, and a peripheral optical multi-layer coating 30 which is deposited on a peripheral region around the ring-shape coating 20.

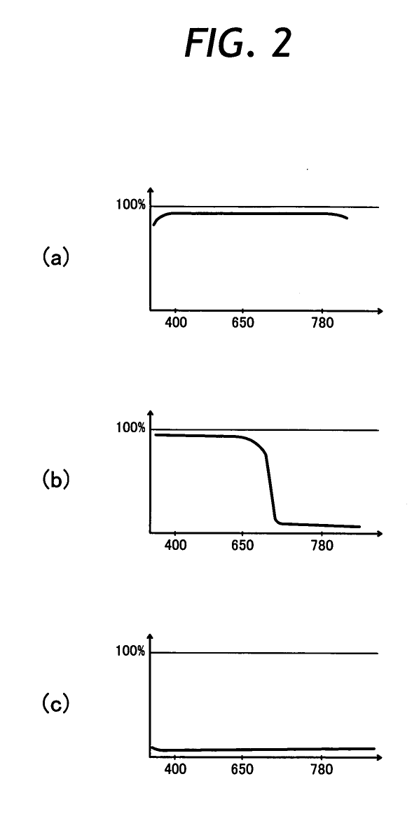

As shown in the graphs in FIG. 2 (transverse axis: wavelength, vertical axis: transmittivity), the circular optical multi-layer coating 10 has characteristics of transmitting laser light at wavelengths of 650 nm and 780 nm (shown at (a) of FIG. 2), the ring-shape optical multi-layer coating 20 transmits laser light of 650 nm but does not transmit laser light of 780 nm (shown at (b) of FIG. 2), and the peripheral optical multi-layer coating 30 has characteristics of not transmitting laser light of 650 nm and 780 nm (shown at (c) of FIG. 2.

The substrate plate B is of a square shape having a length W at each side. The circular multi-layer coating 10 is formed in a circular region of a diameter D1, while the ring-shape multi-layer coating 20 is formed in a circular region of a diameter D2 excepting the circular region of the circular multi-layer coating 10. The region of the circular multi-layer coating 10 a region for transmission of CD laser light. That is to say, laser light for CD is transmitted only through the region of the circular multi-layer coating 10 and not transmitted through other regions of the optical element. The region which encloses the circular optical multi-layer coating 10 and the ring-shape optical multi-layer coating 20 is a region for transmission of DVD laser light. That is to say, DVD laser light is transmitted only through the region of the circular optical multi-layer coating 10 plus the ring-shape optical multi-layer coating 20, and not transmitted through other regions.

Since the circular and ring-shape optical multi-layer coatings 10 and 20 are formed on a square substrate plate B, blank spaces are left in peripheral regions around the ring-shape optical multi-layer coating 20. This is because in most cases optical elements are fabricated collectively on a substrative base material and finally cut into units of optical elements in the shape of square pieces, rather than being fabricated individually and separately of each other. On the other hand, the shape of incident laser light is circular in cross section (or elliptic in the case of obliquely incident laser light), and as a matter of course blanks spaces are left in peripheral regions around the laser light transmission regions. Therefore, a peripheral multi-layer coating 30, an optical multi-layer coating with functions of absorbing all light or totally reflecting light (mainly a coating for absorption of light), is formed on the peripheral regions.

By deposition of the peripheral optical multi-layer coating 30 in the peripheral regions, three different types of optical multi-layer coatings are deposited on the optical element. Alternatively, a light absorbing coating may be deposited on the peripheral regions to prevent adverse effects of external disturbing light. For example, as shown in FIG. 2(c), an optical multi-layer coating non-transmissive of all wavelengths may be deposited in peripheral regions to shut out external disturbing light which might otherwise pose adverse effects by falling into a CD or DVD light path.

Only one ring-shape optical multi-layer coating 20 is deposited on an optical element in the case of the particular embodiment shown in FIG. 1. However, if desired, a plural number of ring-shape multi-layer coatings may be deposited on the optical element. For example, another ring-shape optical multi-layer coating (which is of a larger diameter and of different optical characteristics as compared with the ring-shape multi-layer coating 20) may be deposited in such a position as to circumscribe the first ring-shape optical multi-layer coating 20. Further, it is possible to provide another circular multi-layer optical coating within the circular multi-layer optical coating 10 of FIG. 1. Namely, another circular optical multi-layer coating may be provided in a small circular region within the region of the circular optical multi-layer coating 10 of FIG. 1. In this case, the circular optical multi-layer coating 10 can be regarded as a ring-shape optical coating, and it becomes necessary to sharpen boundaries at the inner periphery of the ring-shape optical multi-layer coating deriving from the circular optical multi-layer coating 10, and at the outer periphery of the second circular optical multi-layer coating which is formed inside of the first circular optical multi-layer coating 10. An optical element can have a wave switching function in a case where a plural number of ring-shape multi-layer coatings of different optical characteristics are deposited in this manner.

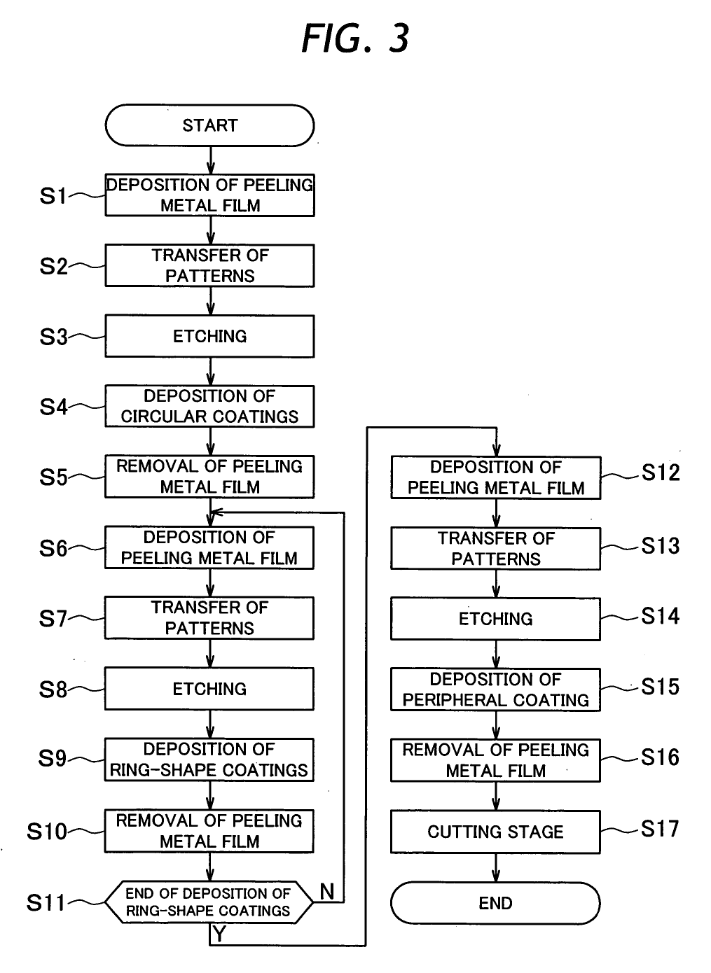

Described below by the use of the flow chart of FIG. 3 is a method for manufacturing optical elements with a single ring-shape optical multi-layer coating 20. In order to deposit each one of three optical multi-layer coatings (the circular multi-layer coating 10, ring-shape multi-layer coating 20 and peripheral multi-layer coating 30) precisely in each one of subsections on a substrative base material BM, optical elements are fabricated through three deposition stages. That is to say, according to the present embodiment, three optical multi-layer coatings are deposited by way of three deposition stages.

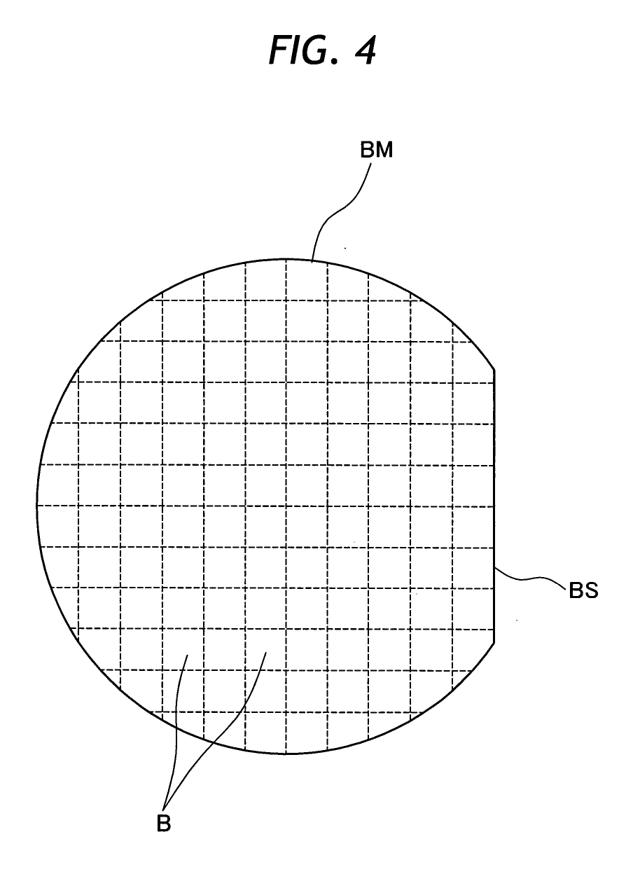

The fabrication of optical elements starts with preparation of a substrative base material (mainly of glass) BM which is in the shape of a circular plate as shown in FIG. 4, part of the circular plate being cut off to provide a straight reference portion BS (generally referred to as “orientation flat side”). This substrative base material BM is imaginarily divided into a plurality of subsections in a checkerboard pattern, each one of the subsections constituting a substrate plate B of one of optical element units of ultimate products. That is to say, after depositing a circular optical multi-layer coating 10, a ring-shape optical multi-layer coating 20 and a peripheral optical multi-layer coating 30 in each one of the subsections, the substrative base material BM is severed along the imaginary checkerboard pattern to separate the individual subsections, fabricating a lot of optical elements simultaneously from one substrative base material BM. However, an alignment mark in the form of an optical multi-layer coating AM is deposited in two subsections of the substrative base material BM for alignment of a mask member.

In a deposition process described below, optical multi-layer coatings are deposited in the order of the circular optical multi-layer coating 10, the ring-shape optical multi-layer coating 20 and the peripheral optical multi-layer coating 30. However, these three optical multi-layer coatings may be deposited in any arbitrary order as long as depositions are carried out by the use of a mask member which is finished with high precision particularly with regard to positions relative to patterns of an optical multi-layer coating as well as patterns of an alignment mark of a multi-layer optical coating AM (hereinafter referred to simply as “an alignment pattern AP”). In this instance, the circular optical multi-layer coating 10 is deposited in the first place in the manner as described below. Used in the initial deposition stage is a first mask member M1.

In the first place, a peeling metal film 10 of aluminum, for example, is deposited on the entire surface of a substrative base material BM (Step 1). In the next place, a photoresist is applied on the peeling metal film 10, and cross-shaped alignment patterns AP and patterns of circular optical multi-layer coatings 10 (hereinafter referred to simply as “circular patterns 10P) are transferred by the use of a first mask member M1. The first mask member M1 is employed to form an alignment pattern in two subsections of the substrative base material BM while forming a circular pattern 10P of the circular optical multi-layer coating 10 in each one the remaining subsections. For example, the first mask member M1 has the alignment patterns AP and circular patterns 10P printed on a transparent substrate plate of glass or the like. The first mask member M1 should be finished strictly with high precision with respect to relative positions of the alignment patterns AP and circular patterns 10P. Further, the first mask member M1 is provided with a matching side MS as a reference portion, correspondingly to the reference portion BS on the part of the substrative base material BM.

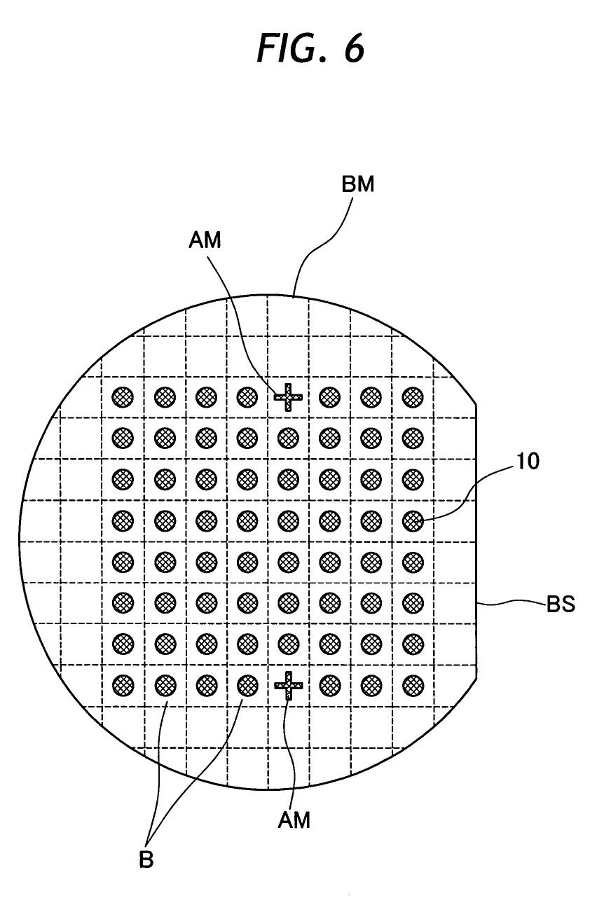

After matching the reference portion MS with the reference portion BS of the substrative base material BM, for example, an ultraviolet ray is irradiated from above. At this time, photoresist in masked areas (hatched areas in the drawings) remains unsensitized while photoresist in other areas is sensitized. Then, the surface of the substrative base material BM is etched after removing photoresist in sensitized areas (Step 3). Whereupon, areas of alignment patterns AP and circular patterns 10P are exposed on the surface of the substrative base material BM, while other areas are still covered with the peeling metal film 80. In this state, circular optical multi-layer coatings 10 are deposited on the entire surface of the substrative base material BM (Step 4). Upon removing the peeling metal film 80 which still remains on the substrative base material BM (Step 5), there is obtained a product of the initial deposition stage, having an alignment mark optical multi-layer coating AM deposited in two subsections of the substrative base material BM and an optical circular multi-layer coating 10 in each one of other subsections as shown in FIG. 6. At this time, the first mask member M1 is registered on the substrative base material BM by matching the reference portions BS and MB prior to transfer of patterns, so that there may be possibilities of deviational errors occurring to the mask member M1. However, since the alignment patterns AP and the circular patterns 10P in the first mask member M1 are provided in extremely strict positions relative to each other in an extremely strict, there is no possibility of errors occurring in relative positions of the alignment mark optical multi-layer coatings AM and the circular optical multi-layer coatings 10. In case an error has occurred more or less to whole positions of the alignment mark optical multi-layer coatings AP and the circular optical multi-layer coatings 10, it can be corrected by adjusting cutting positions of the substrative base material BM in a later cutting stage to obtain optical elements each having the respective optical multi-layer coatings deposited in correct positions.

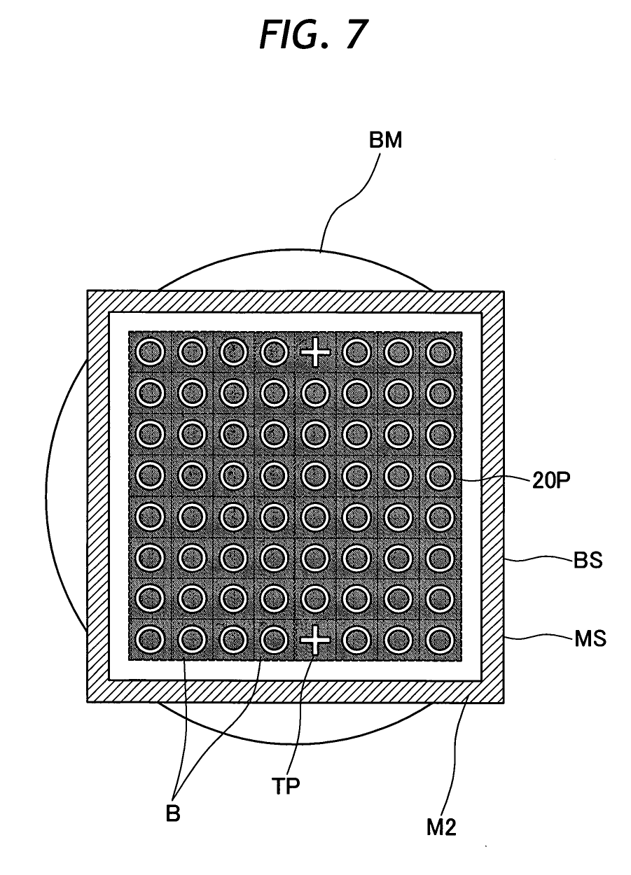

Now, the ring-shape optical multi-layer coatings 20 deposited in a second deposition stage in the following manner. In this stage, a peeling metal film 80 is deposited on the substrative base material BM which has the alignment mark optical multi-layer coatings AM and the circular optical multi-layer coatings 10 deposited on the respective subsections as described above (Step 6). Then, a photoresist is applied on the entire surface of the metal film 80, and patterns of the ring-shape optical multi-layer coatings 20 (hereinafter referred to simply as “ring patterns 20P) are transferred by the use of a second mask member M2 as shown in FIG. 7 (Step 7). The second mask member M2 is provided with an alignment pattern recognition pattern TP in two subsections which are in corresponding positions relative to the subsections of the alignment mark optical multi-layer coating AM on the substrative base material BM, in addition to ring pattern 20P which are formed in the remaining subsections in strictly controlled positions relative to the alignment mark recognition patterns TP. Similarly to the first mask member M1, the transferring patterns of the second mask member M2 are formed, for example, on a transparent substrate plate of glass by printing or other suitable means.

In this instance, the shape of the alignment mark recognition pattern TP is same as that of the alignment pattern AP (a cross shape) but slightly larger in outer shape as compared with the alignment pattern AP. Namely, the alignment mark recognition pattern TP is arranged to block light outside a cross pattern similarly to the alignment pattern AP but is slightly larger in outer shape than the alignment pattern AP.

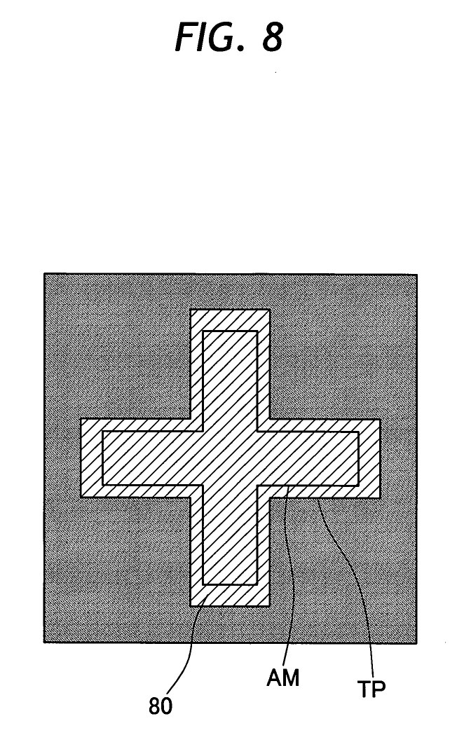

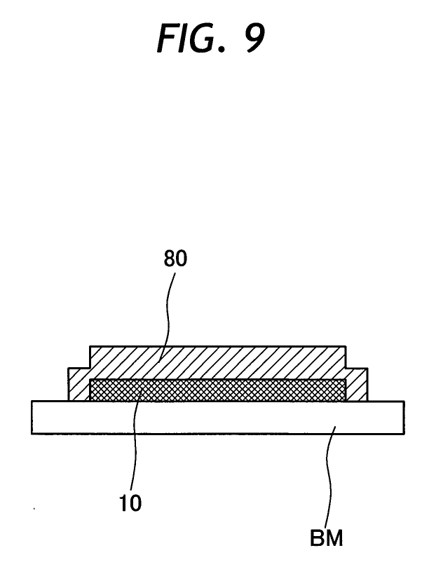

The alignment pattern recognition patterns TP in the second mask member M2 are registered on the alignment mark optical multi-layer coatings AM prior to transfer of patterns. Shown in FIG. 8 is an alignment mark recognition pattern TP which is positioned in registry with an alignment mark optical multi-layer coating AM. The cross pattern of the alignment mark recognition pattern TP in the second mask member M2 is substantially a punched-out pattern, permitting to recognize the alignment mark optical multi-layer coating AM inside of the punched-out pattern area. In this connection, it is the general practice to resort to a microscope or a TV camera for fine adjustments in bringing the alignment mark recognition pattern TP and the alignment mark optical multi-layer coating AM into exactly aligned positions. However, the alignment mark optical multi-layer coating AM cannot be recognized at the time of pattern transfer because the peeling metal film 80 is already deposited on the alignment mark optical multi-layer coating AM. In this regard, as shown in FIG. 9, a region of the peeling metal film 80 which is deposited on the alignment mark optical multi-layer coating AM is located at a higher level as compared with other regions of the peeling metal film 80 (the regions which are deposited directly on the substrative base material BM), to an extent corresponding to the thickness of the peeling metal film 80 itself. Thus, the alignment mark AM can be recognized from above by way of ridgelines of the relief region which is deposited on the alignment mark optical multi-layer coating AM and raised from other regions of the peeling metal film 80.

As a method for bringing center positions of the alignment pattern recognition pattern TP and the alignment mark optical multi-layer coating AM strictly into alignment with each other by the use of a microscope or a TV camera, fine adjustments may be made in such a way as to uniformalize the gap width between the alignment mark recognition pattern TP and the alignment mark optical multi-layer coating AM, that is to say, in such a way as to leave a gap of uniform width between the alignment pattern recognition pattern TP and the alignment mark optical multi-layer coating AM. By so doing, a center of the alignment mark recognition pattern can be brought into alignment strictly with a center of the alignment mark optical multi-layer coating AM to realize high precision alignment. In the particular embodiment shown, a cross-shape alignment mark is used for the alignment mark optical multi-layer coating AM and the alignment mark recognition pattern TP. Needless to say, the alignment mark may be of other shapes, for example, a square or circular shape although it is preferred to employ an alignment mark which has a large number of sides like a cross mark.

The above-described second mask member M2 is set in an aligned position by high precision alignment in reference to the alignment mark optical multi-layer coating AM on the substrative base material BM, and then irradiated, for example, with an ultraviolet ray from above to transfer the patterns of the second mask member M2, followed by etching (Step 8). After deposition of ring-shape optical multi-layer coatings 20 on the entire surface of the substrative base material (Step 9), the remaining peeling metal film 80 is peeled off (Step 10). At this time, since the alignment pattern recognition patterns TP in the second mask member M2 is larger in outer shape than the alignment patterns AP in the first mask member M1, fresh alignment mark multi-layer optical coatings AM deposited with the ring-shape optical multi-layer coatings 20 and slightly larger in outer shape than the alignment mark optical multi-layer coatings AM of the first mask member M1 are left on the substrative base material BM.

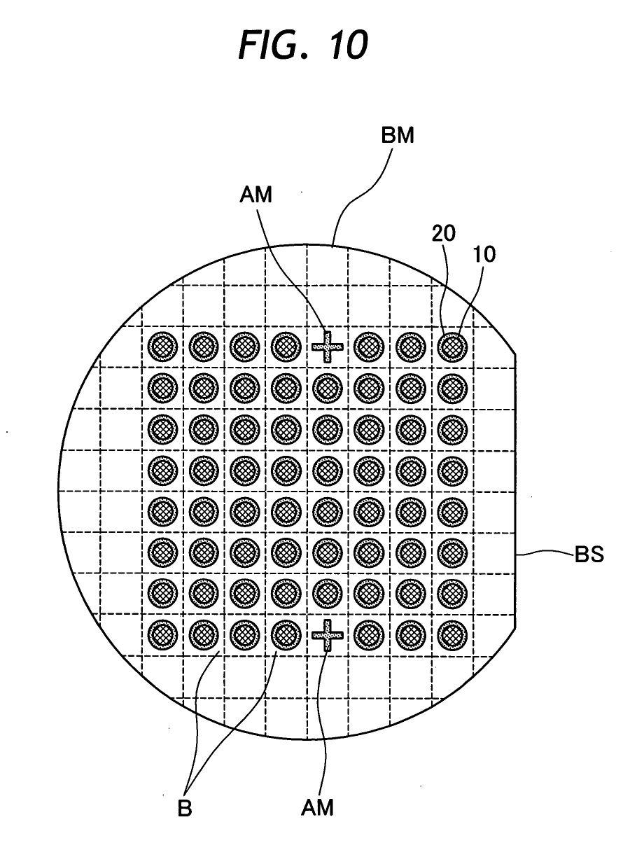

As a result of the foregoing deposition process, as shown in FIG. 10, a circular optical multi-layer coating 10 and a ring-shape optical multi-layer coating 20 are deposited on each one of subsections on the substrative base material (except the subsections on which an alignment mark optical multi-layer coating AM is deposited). Since the alignment pattern recognition patterns TP are provided in corresponding positions relative to the first mask member M1, the second mask member M2 can be brought into an aligned state with high precision, in reference to the alignment mark optical multi-layer coatings AM. Accordingly, each one of the ring-shape optical multi-layer coatings 20 can be deposited in such a way as to circumscribe a circular optical multi-layer coating 10 by an extremely clearly defined border.

In case another ring-shape optical multi-layer coating is deposited around the outer periphery of the first ring-shape optical multi-layer coating 20 (Step 11), the deposition process from Step 6 to Step 12 is repeated.

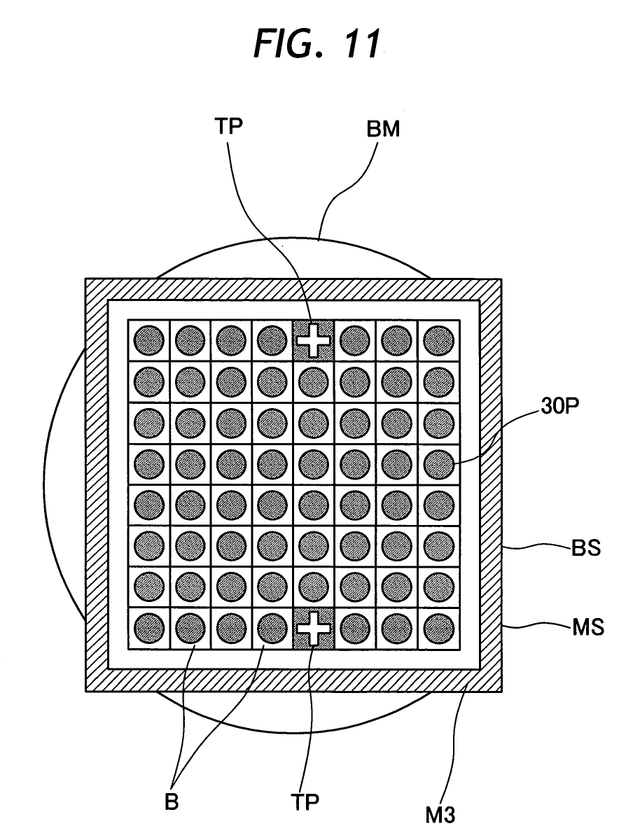

Now, a peripheral optical multi-layer coating 30 is deposited in a third deposition stage in the manner as follows. In the first place, a peeling metal film 80 is deposited on the substrative base material with the circular and ring-shape optical multi-layer coatings 10 and 20 deposited thereon as described above (Step 12). Then, after applying a photoresist on the entire surface of the substrative base material, patterns of the peripheral multi-layer optical coating 30 are transferred by the use of a third mask member M3 as shown in FIG. 11 (Step 13). This third mask member M3 is also provided with alignment mark recognition pattern PT in two subsections corresponding to alignment mark optical multi-layer coatings AM, and in other subsections, provided with patterns of the peripheral optical multi-layer coating 30 (hereinafter referred to simply as “peripheral patterns 30P”). As in the case of the first and second mask members M1 and M2, these transferring patterns are printed on a transparent substrate of glass or the like. Likewise, the third mask member M3 uses a cross mark for the alignment mark recognition patterns TP, which are larger in outer shape than the alignment mark recognition patterns TP on the second mask member M2. The alignment mark recognition pattern TP is arranged to block light outside a cross mark.

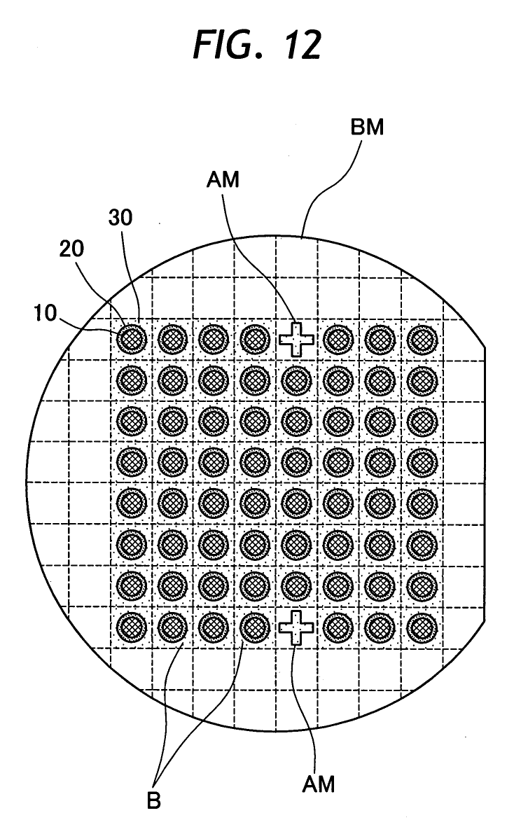

For the purpose of transfer of patterns, the alignment mark recognition patterns TP in the third mask member M3 is aligned with alignment mark optical multi-layer coatings AM of the ring-shape optical multi-layer coatings 20 which are freshly deposited on the substrative base material BM. At this time, high precision alignment is feasible by recognizing edges of the peeling metal film 80 which is deposited on the ring-shape optical multi-layer coating 20 as a relief raised from the peeling metal film 80 deposited on the substrative base material BM, through the cross mark (substantially a punched-out cross mark area) of the alignment mark recognition pattern TP of the third mask member M3. Then, transferred patterns are etched (Step 14), and a peripheral optical multi-layer coating 30 is deposited on the entire surface of the substrative base material BM (Step 15), followed by removal of remaining metal film 80 (Step 16). As a consequence, as shown in FIG. 12, a circular optical multi-layer coating 10, a ring-shape optical multi-layer coating 20 and a peripheral optical multi-layer coating 30 are deposited on each one of subsections of the substrative base material BM (except for the subsections with an alignment mark optical multi-layer coating AM).

At this time, the third mask member M3 can be aligned with high precision in reference to the alignment mark optical multi-layer coatings AM co-deposited with the ring-shape optical multi-layer oatings 20, defining an extremely sharp border between a ring-shape optical multi-layer coating 20 and a peripheral optical multi-layer coating 30 in each subsection of the substrative base material BM.

In a final stage, the substrative base material BM, deposited with a circular optical multi-layer coatings 10, a ring-shape optical multi-layer coatings 20 and a peripheral optical multi-layer coating 30 in each one of the subsections which are arranged in a checkerboard pattern, is cut to separate individual subsections from each other to obtain a plural number of optical elements (Step 17).

As described above, the first optical multi-layer coatings are deposited by the use of the first mask member M1 which is arranged to deposit alignment mark optical multi-layer coatings AM in strictly controlled positions relative to the first optical multi-layer coatings. In reference to the alignment mark optical multi-layer coatings AM which have been co-deposited with the first optical multi-layer coatings, next or second optical multi-layer coatings are deposited in precisely aligned positions. Namely, in reference to alignment mark multi-layer optical coatings which are deposited in a previous deposition stage, next optical multi-layer coatings can be deposited in accurate positions with extremely high precision.

In the above-described embodiment, among the first to third mask members which are used by way of example in the first to third deposition stages, the alignment mark recognition pattern TP in the second mask member M1 is larger in outer shape than that of the alignment mark recognition pattern TP in the first mask member M1, and the alignment mark recognition pattern TP in the third mask member M3 is still larger in outer shape than the alignment recognition pattern TP in the second mask member M2. However, there may be employed mask members among which an alignment pattern AP in a first mask member is largest in outer shape, and alignment mark recognition patterns TP in second and third mask members M2 and M3 are stepped down in outer shape. In such a case, alignment patterns AP and alignment mark recognition patterns TP are constituted by a cross mark which is arranged to block light inside a cross and not to block light outside a cross to permit recognition of an alignment mark optical multi-layer coating AM. By so arranging, it becomes possible to recognize an alignment mark optical multi-layer coating AM from a previous deposition stage through peripheral portions of a mask member in a succeeding deposition stage to realize alignment of extremely high precision.

On the other hand, all of optical multi-layer coatings in succeeding deposition stages can be deposited in exactly aligned position in reference to an alignment mark optical multi-layer coating deposited in the initial deposition stage, instead of using an alignment mark optical multi-layer coating deposited in an immediately preceding deposition stage, as described below.

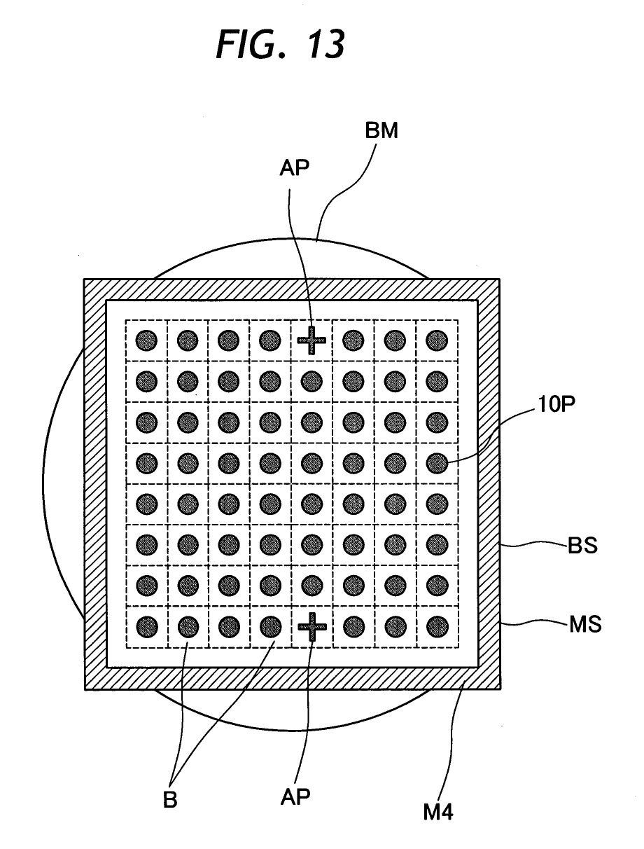

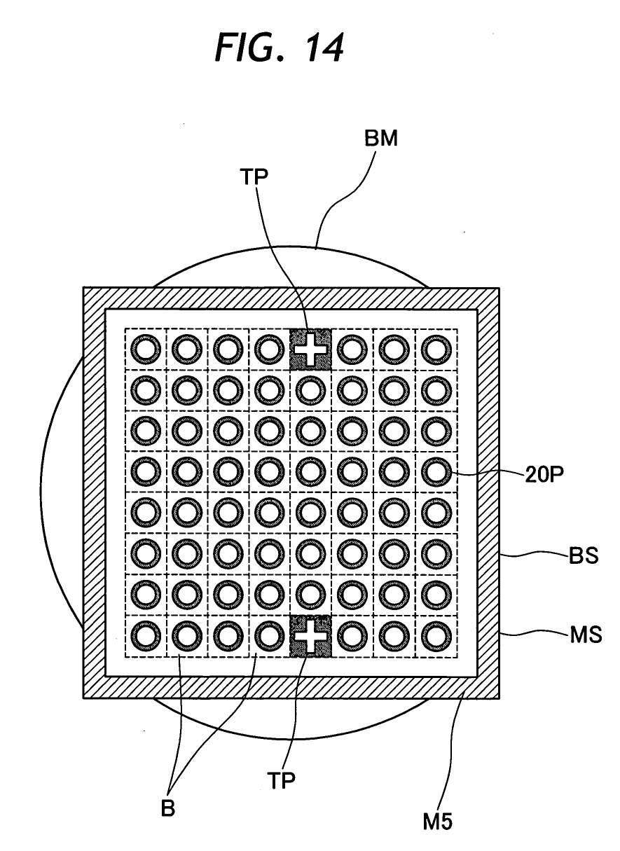

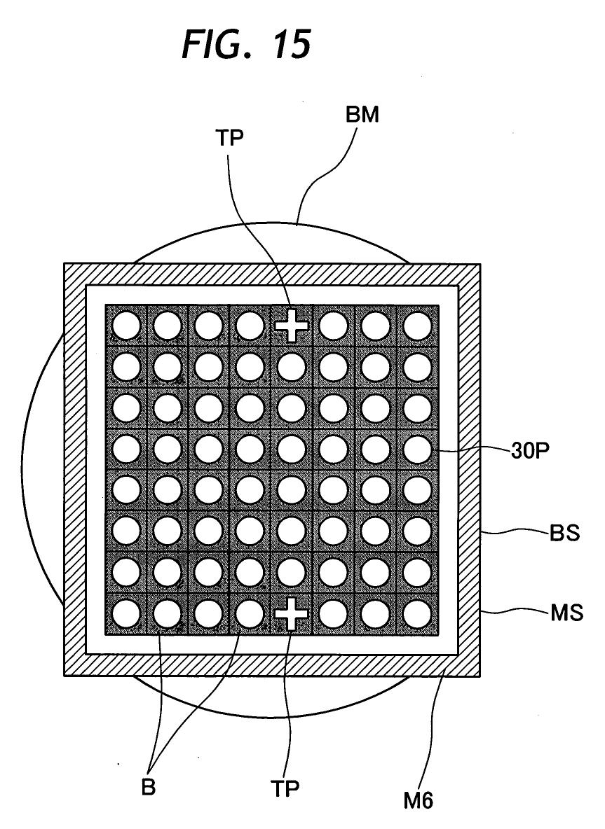

In this case, on a substrative base material as shown in FIG. 4, circular optical multi-layer coatings 10 are deposited by the use of a fourth mask member M4 with patterns as shown in FIG. 13, ring-shape optical multi-layer coatings 20 are deposited by the use of a fifth mask member M5 shown in FIG. 14, and peripheral optical multi-layer coatings 30 are deposited by the use of a sixth mask member M6 shown in FIG. 15. In this instance, patterns of light blocking and non-blocking regions in each one of subsections of optical multi-layer coatings on the fourth to sixth mask members M4 to M6 are reversed as compared with the patterns on the first to third mask members M1 to M3. In contrast, alignment patterns AP are arranged to block light inside a cross mark, while alignment mark recognition patters TP are arranged to block light outside a cross mark. Further, alignment patterns AP on a mask member to be used in an initial deposition stage (i.e., a fourth mask member M4) is slightly larger in outer shape than alignment mark recognition patterns TP on mask members to be used in succeeding deposition stages (i.e., on the fifth and sixth mask members M5 and M6). Outer shapes of alignment mark recognition patterns TP in succeeding deposition stages are all same in outer shape or in size. Of course, even in this case, the alignment mark optical multi-layer coatings AM as well as the alignment mark recognition patterns TP are not limited to a cross mark, and may be in a square or circular shape if desired.

The above-described fourth to sixth mask members M4 to M6 are used in the respective deposition stages in the manner as follows. In the first place, a peeling metal film 80 is deposited on a substrative base material BM shown in FIG. 4, and a photoresist is applied on the metal film 80. Then, after aligning the fourth mask member M4 by way of a reference portion of BS, an ultraviolet ray is irradiated from above to transfer patterns of the fourth mask member M4 by leaving light-blocked regions unsensitized while sensitizing other regions. Photoresist in a sensitized region is removed in the foregoing embodiment. However, in the case of this embodiment, photoresist is removed form unsensitized regions. Accordingly, the photoresist which is applied on the peeling metal film 80 is removed from those regions which corresponding to light-blocking regions of the fourth mask member M4. Then, the substrative base material BM is subjected to etching to deposit circular optical multi-layer coatings 10 on the entire surface of the substratve base material BM. Upon stripping off the peeling metal film 80, there is obtained a substrative base material with the circular optical multi-layer coatings 10 and alignment mark optical multi-layer coatings AM deposited thereon.

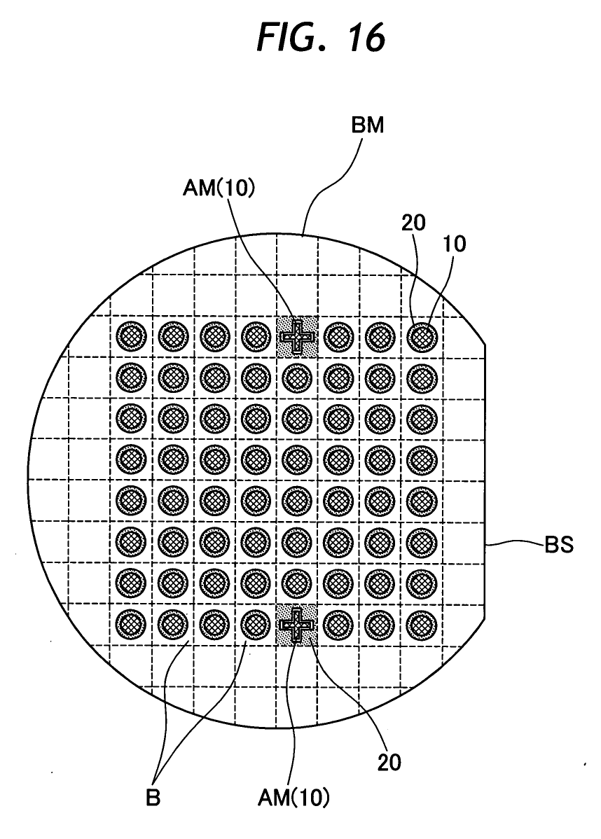

Shown in FIG. 14 is the fifth mask member M5 to be aligned on the subsrative base material in a next deposition stage for transfer patterns of ring-shape optical multi-layer coatings 20. In the first place, a peeling metal film 80 is deposited on the surface of the substrative base material BM, bearing the circular optical multi-layer coatings 10 and alignment mark optical multi-layer coatings AM which were deposited in a previous deposition stage, following by application of a photoresist. Then, aligning the fifth mask member M5 with high precision by recognizing alignment mark optical multi-layer coatings AM through and inward of alignment mark recognition patters of a cross shape (substantially in a punched-out cross shape) which are provided on the fifth mask member M5, followed by irradiation of an ultraviolet ray for transfer of patterns of the fifth mask member M5. Photoresist in light-blocked regions remains unsensitized but photoresist in other region is sensitized. In this instance, as explained hereinbefore, after removing photoresist in unsensitized regions, followed by etching and deposition of the ring-shape optical multi-layer coatings 20 on the entire surface of the substrative base material BM. Upon stripping off the peeling metal film 80, there is obtained a substrative base material BM having the ring-shape optical multi-layer coatings 20 deposited around the circular optical multi-layer coatings 10 as shown in FIG. 16. At this time, the fifth mask member M5 aligned with high precision by way of the alignment mark optical multi-layer coatings AM which were deposited in the initial deposition stage. Accordingly, the ring-shape optical multi-layer coatings 20 can be deposited around the circular optical multi-layer coatings 10, each defining an extremely sharp non-overlapping border around a circular optical multi-layer coating 10. The peeling metal film 80 which remains around the alignment mark optical multi-layer coatings AM, which was formed in the initial deposition stage, is completely removed at the time of stripping off the peeling metal film 80, so that the alignment mark optical multi-layer coatings AM from the initial deposition stage are completely exposed on the surface of the substrative base material BM.

Finally, for transfer of patterns, the sixth mask member M6 of FIG. 15 is aligned on the substrative base material BM having the circular and ring-shape optical multi-layer coatings 10 and 20 thereon in the preceding deposition stages. In the first place, a peeling metal film 80 is deposited on the substrative base material BM, followed by application of a photoresist. Then, the sixth mask member M6 is aligned with high precision by way of the alignment mark optical multi-layer coatings AM on the substrative base material BM, which can be seen through and inward of alignment mark recognition patterns TP, which are provided on the sixth mask member M6 in the form of a cross (substantially a punched-out region). After that, an ultraviolet ray is irradiated from above to transfer patterns of the sixth mask member M6. Photoresist in light-blocked regions remains unsensitized while photoresist in other regions is sensitized by irradiation of an ultraviolet ray. In this case, the photoresist in unsensitized regions is removed, followed by etching and deposition of peripheral optical multi-layer coatings 30. After stripping off the peeling metal film 80, there is obtained a substrative base material BM with a circular optical multi-layer coating 10, a ring-shape optical multi-layer coating 20 and a peripheral optical multi-layer coating 30 in each one of checkerboard-like subsections (except two subsections with an alignment mark optical multi-layer coating AM).

In the third deposition stage, the sixth mask member M6 is aligned by way of alignment mark optical multi-layer coatings AM which were deposited on the substrative base material BM in the initial deposition stage. Namely, in the stage of depositing the ring-shape optical multi-layer coatings 20, the alignment mark optical multi-layer coatings AM, which were co-deposited with the circular optical multi-layer coatings 10, are exposed on the surface of the substrative base material BM. Therefore, the sixth mask member M6 can be aligned with high precision, in reference to the alignment mark optical multi-layer coatings AM which were deposited in the initial deposition stage. Accordingly, each one of the circular, ring-shape and peripheral optical multi-layer coatings 10, 20 and 30 can be deposited precisely in a correct position and in such a way as to define an extremely sharp border.

Namely, a mask member to be used in the initial deposition stage is provided with alignment patterns AP which are arranged to block light inside a cross mark, while mask members to be used in succeeding deposition stages are provided with an alignment mark recognition patterns which are arranged to block light outside a cross mark which is slightly larger in outer shape than the cross mark of the alignment mark optical multi-layer coating AM. The cross marks of alignment mark recognition patterns on mask members for use in succeeding deposition stages are identical with each other in outer shape. Therefore, the alignment mark optical multi-layer coatings AM which is deposited in the initial deposition stage are completely exposed on the substrative base material BM in succeeding deposition stages. Besides, the alignment mark optical multi-layer coatings AM which are deposited and maintained on a glass substrate plate are unsusceptible to deformations or deteriorations in shape and to partial defoliations as well. It follows that, in succeeding deposition stages, mask members are aligned always in reference to alignment mark optical multi-layer coatings AM which were deposited in an initial deposition stage.

Thus, in depositing optical multi-layer coatings in succeeding deposition stages, the respective mask members can be aligned with high precision in reference to alignment mark optical multi-layer coatings AM which is deposited in an initial deposition stage, to transfer patterns of the respective mask members to precisely correct positions. This means that the respective optical multi-layer coatings can be deposited in correct positions and with a sharp and clear border.

In the present embodiment, by way of example three different optical multi-layer coatings are deposited in each subsection on the substrative base material BM. Needless to say, the present invention can be similarly applied to optical elements with two different optical multi-layer coatings. Since alignment mark optical multi-layer coatings are deposited on a substrative base material simultaneously with deposition of optical multi-layer coatings in an inital deposition stage, another optical multi-layer coatings can be deposited in accurately aligned positions in a succeeding deposition stage in reference to the alignment mark optical multi-layer coatings on the substrative base material.

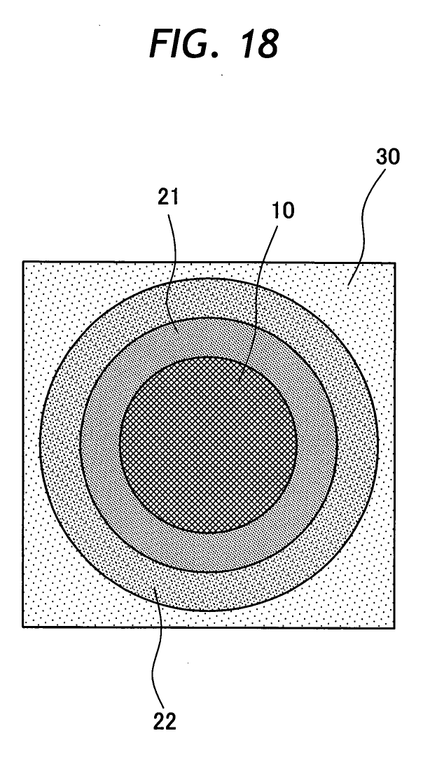

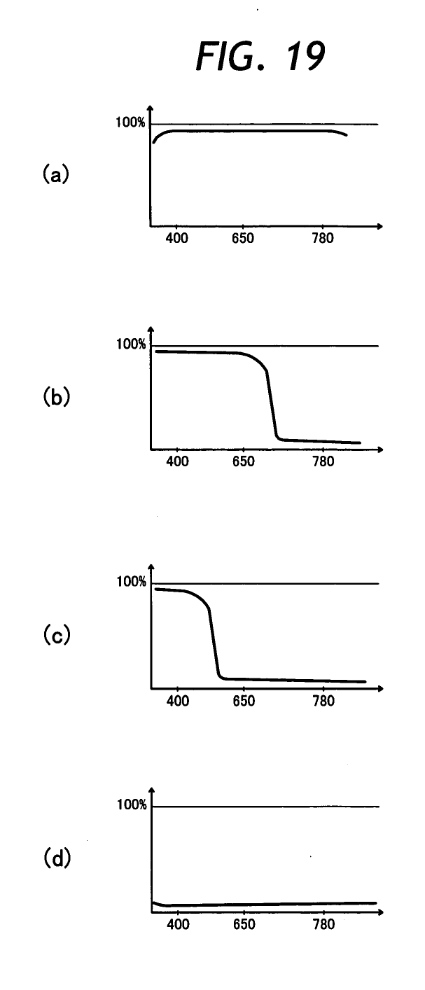

On the other hand, the present invention can be applied not only to optical elements with two kinds of optical multi-layer coatings but to optical elements with more than three kinds of optical multi-layer coatings. For example, it is possible to apply the present invention to an optical element with two ring-shape optical multi-layer coatings as shown in FIG. 18. Lately, in addition to CD and DVD, optical discs of new generation, using short wave laser light of 400 nm (or of a wavelength approximately 400 nm) were introduced and put to use. In this regard, an optical element with wave selecting functions for laser beams of 780 nm, 650 nm and 400 nm can be produced by depositing at the center of a substrate plate B a circular optical multi-layer coating 10 which is transmissive of all wavelengths as shown in FIG. 19(a), while depositing around the circular optical multi-layer coating 10 a first ring-shape optical multi-layer coating 21 (identical with the ring-shape optical multi-layer coating 20 in the foregoing embodiments) which is transmissive of laser beams of 400 nm and 650 nm but not transmissive of a laser beam of 780 nm as shown in FIG. 19(B), a second ring-shape optical multi-layer coating 22 which is transmissive of a laser beam of 400 nm alone and not transmissive of laser beams of 650 nm and 780 nm as shown in FIG. 19(c), and, on the outer side of the second ring-shape optical multi-layer coating 22, a peripheral optical multi-layer coating 30 which has characteristics of absorbing all wavelengths as shown in FIG. 19(d).

Even in this case, alignment marks of optical multi-layer coatings AM are deposited in an initial deposition stage simultaneously with deposition of the first optical multi-layer coating, so that patterns of the second, third and fourth optical multi-layer coatings can be aligned with high precision in succeeding deposition stages, in reference to the alignment mark optical multi-layer coatings AM which are freshly deposited in an immediately preceding deposition stage. Thus, a plural number of optical multi-layer coatings can be deposited accurately in aligned positions. That is to say, in reference to alignment marks of optical multi-layer coatings AM which are deposited in two subsections on a substrative base material BM, one or two or more kinds of optical multi-layer coatings can be deposited accurately in aligned positions. Of course, as in the above-described modification, in reference to alignment mark optical multi-layer coatings which are deposited in an initial deposition stage, patterns of optical multi-layer coatings can be aligned in all succeeding deposition stages.

The above-described circular, ring-shape and peripheral optical multi-layer coatings 10, 20 and 30 should be smaller than the peeling metal film 80 in thickness. If these optical multi-layer coatings are greater in thickness than the peeling metal film 80, it may become difficult to sever optical multi-layer coatings on the peeling metal film from optical multi-layer coatings on the substrative base material completely in boundary portions at the time of stripping off the peeling metal film 80. Therefore, from the standpoint of sharpening borders, the respective optical multi-layer coatings should be smaller in thickness than the peeling metal film 80.

What is claimed is:

1. A method for manufacturing an optical element having a plural number of different optical multi-layer coatings deposited on a surface of a rectangular substrate plate through a plural number of deposition stages each comprising depositing a peeling metal film on a surface of a substrative base material, dividing said substrative base material into a plural number of rectangular subsections, transferring a pattern to each subsection by the use of a mask member, etching said peeling metal film, depositing an optical multi-layer coating on each one of said subsections, and stripping off said peeling metal film, and finally cutting said substrative base material to separate said subsections from each other;
characterized in that said method comprises the steps of:
using in an initial deposition stage a mask member being provided with an alignment pattern in two subsections in addition to patterns of an optical multi-layer coating to be transferred to other subsections, for depositing an alignment mark of an optical multi-layer coating at two position on said substrative base material; and
using in a succeeding deposition stage another mask member being provided with a light transmitting portion at positions corresponding to said alignment marks of optical multi-layer coatings, and being aligned relative to said substrative base material by recognizing through said light transmitting portion said alignment marks covered under a peeling metal film.

2. A method for manufacturing an optical element as defined in claim 1, wherein mask members to be used in succeeding deposition stages are step by step minimized or enlarged in outer shape of said light transmitting portion, and aligned in reference to alignment mark of optical multi-layer coatings deposited in an immediately preceding deposition stage.

3. A method for manufacturing an optical element as defined in claim 1, wherein said alignment marks of optical multi-layer coatings deposited in an initial deposition stage are exposed on a surface of said substrative base material upon stripping off said peeling metal film, permitting said another mask member in reference to the initial alignment marks in said succeeding deposition stage.

4. A method for manufacturing an optical element as defined in claim 1, wherein said optical element is deposited with a plural number of different optical multi-layer coatings, including a circular optical multi-layer coating deposited at the center of a square substrate plate, one or a plural number of ring-shape optical multi-layer coatings deposited around said circular optical multi-layer coating, and a peripheral optical multi-layer coating deposited on outer side of said ring-shape optical multi-layer coating or coatings.

5. A method for manufacturing an optical element as defined in claim 1, wherein a mask member in a succeeding deposition stage is aligned by recognition of relief portions of said peeling metal film deposited on said alignment marks of optical multi-layer coatings and raised from other peeling metal film portions.
